(19) United States
(12) Patent Application Publication
(10) Pub. No.: US 2002/0120844 A1
(43) Pub. Date: Aug. 29, 2002

(54) Authentication and distribution of keys in mobile IP network

(76) Inventors: Stefano Faccin, Dallas, TX (US); Franck Le, Irving, TX (US)

Correspondence Address: ALTERA LAW GROUP, LLC, 6500 CITY WEST PARKWAY, SUITE 100, MINNEAPOLIS, MN, 55344, US

(21) Appl. No.: 09/792,682

(22) Filed: Feb. 23, 2001

(51) Int. Cl. H04L 9/00

(52) U.S. Cl. 713/168; 380/270; 380/277

(57) ABSTRACT

There is disclosed a method of establishing a connection between a mobile station and a serving domain, in which a first security association exists between the mobile node and an associated home domain, and a second security association exists between the serving domain and the home domain, the method comprising: transmitting a first message from the mobile node to the serving domain, the first message being encrypted in accordance with the first security association; transmitting the first message from the serving domain to the home domain; decrypting the first message in the home domain in accordance with the first security association; transmitting a second message from the home domain to the serving domain, the second message being encrypted according to the first security association; transmitting the second message from the serving domain to the mobile node; decrypting the second message in the mobile node in accordance with the first security association.

### FIELD OF THE INVENTION

This invention is related to Mobile IP (Internet Protocol) based network architecture and more particularly Mobile IP based cellular networks.

### BACKGROUND TO THE INVENTION

Many developing network architectures are based on Mobile IP. However, using the Mobile IP protocol for mobility, the mobile node (MN) needs to share a security association with its Home Agent (HA) in its home domain or home network. In addition if hierarchical mobility mechanisms (such as MIPv6RR-regional registration or HMIPv6-Hierarchical Mobile IPv6) are used to optimise signalling in the network, at least one other security association needs to be set up between the mobile node and the Mobility Agent in the visited or serving domain.

If the mobile node is also accessing the network through an access network with a link layer connection that requires ciphering of the data transmitted over the access link in order to protect the data from eavesdropping, another security association must be agreed upon between the MN and some entity in the access network to cipher the data carried over the access link.

Therefore three set of keys need to be distributed for a MN in a Mobile IP network:

i) The Mobile IP key set to be shared between the MN and its Home Agent, termed Km.

ii) The key for the hierarchical mobility mechanism set to be shared between the MN and the Mobility Agent in the visited domain termed Ks.

iii) The Ciphering key to encrypt data over the access link if the MN is accessing the network through an access network with a link layer connection that requires ciphering of the data, termed Kc.

Today many key distribution protocols exist such as Internet Key Exchange [RFC 2409], Kerberos, etc. to distribute the keys. However these protocols require many messages to be exchanged. As in radio access networks radio resources are limited, such current solutions which rely on many message are not appropriate. When the access network uses a wireless access link (e.g. in cellular networks), it is highly desirable to reduce the number of messages to be sent over the air interface.

For authentication of the MN and for key distribution some generic mechanisms such as IKE, Kerberos, etc. exist, but they also require many messages to be exchanged, and are thus not suitable for networks using a wireless access link such as cellular networks. In addition many of these solutions distribute the keys by sending them encrypted. However this must be avoided in networks using a wireless access link such as cellular networks, since the wireless link is easily subject to eavesdropping and thus there is the danger of having the keys intercepted. Even if the keys are distributed over the access link by encrypting them, the danger of having the keys intercepted is still too large and this type of solution has traditionally been avoided for networks using a wireless access link such as cellular networks.

One internet draft, ‘AAA Registration Keys for Mobile IP (draft-ietf-mobileip-aaa-key-01.txt)’, suggests a way to derive the Mobile IP security associations. However the Mobile IP key is sent over the air interface (encrypted), and this must be avoided in cellular networks. In addition this Internet Draft just suggests how to derive the Mobile IP keys. It is an object of the present invention to provide an improved technique for the authentication of the mobile nodes and distribution of keys in a network, and particularly a mobile IP network.

### SUMMARY OF THE INVENTION

This invention describes two methods to distribute the necessary keys in an optimised way. An authentication method is also provided. The authentication procedure provides both user authentication and network authentication.

This invention introduces an optimised authentication and key distribution mechanisms for a mobile node in a Mobile IP based cellular network.

The authentication mechanism provides mutual authentication and is based on challenge-response mechanism. The key distribution procedure requires a minimal number of messages. The key distribution procedure does not require any key, even encrypted, to be sent over the air interface.

Two specific key distribution methods are described in two embodiments. A first method is based on random values, and a second is based on Diffie Hellman values.

This invention enables a network to authenticate a mobile node and a mobile node to authenticate the network. The required security associations in a Mobile IP network architecture are set up without sending an excess of messages over the air interface, and without sending any keys (even encrypted) over the air interface.

The present invention describes a way to authenticate the keys as well as derive them. The authentication and key distribution are advantageously combined in order to reduce the number of messages, but these two procedures may also be performed separately.

The technique of the present invention has a number of significant advantages. The procedure does not require many messages to be sent over the air interface. The key distribution mechanisms do not require the key to be sent over the air interface. The key distribution method based on Diffie Hellman is more flexible for a future evolution towards Public Key Infrastructure (PKI).

### BRIEF DESCRIPTION OF THE DRAWINGS

The invention will now be described with regard to illustrative examples by way of reference to the accompanying drawings, in which:

FIG. 1 illustrates a first embodiment of the present invention;

FIG. 2 illustrates a second embodiment of the present invention;

FIG. 3 illustrates a first modification to the first embodiment of the present invention,

FIG. 4 illustrates a second modification to the first embodiment of the present invention; and

FIG. 5 illustrates a third modification to the first embodiment of the present invention.

### DESCRIPTION OF PREFERRED EMBODIMENTS

The present invention is described herein with reference to particular, non-limiting examples. One skilled in the art will appreciate the applicability of the present invention in applications other than those specifically disclosed herein.

The process of initial registration, that may occur when a mobile node (MN) powers on or when a MN enters a new visited network, is described in the following. The user is identified by a Network Address Identifier (NAI) and is authenticated by the network.

At the initial registration, the MN may not have any home agent (HA) assigned to serve it, and may not have the appropriate security keys for communication. In such case, home agent assignment and key distribution happen upon user request during the initial registration.

The mobile node actually requires three sets of key:

i) A Mobile IP key set to be shared between the mobile and its home network including the associated home agent, termed Km.

ii) A key for the hierarchical mobility mechanism set to be shared between the MN and the visited or serving domain, termed Ks.

iii) A Ciphering key to encrypt the data over the access link if the MN is accessing the network through an access network with a link layer connection that requires ciphering of the data, termed Kc.

Notations: K (data1, data2): (data1, date2) are sent encrypted with the key K.

Notations: CK, IK (data1, data2): (data1, data2) are sent encrypted with the key CK and integrity protected with the key IK.

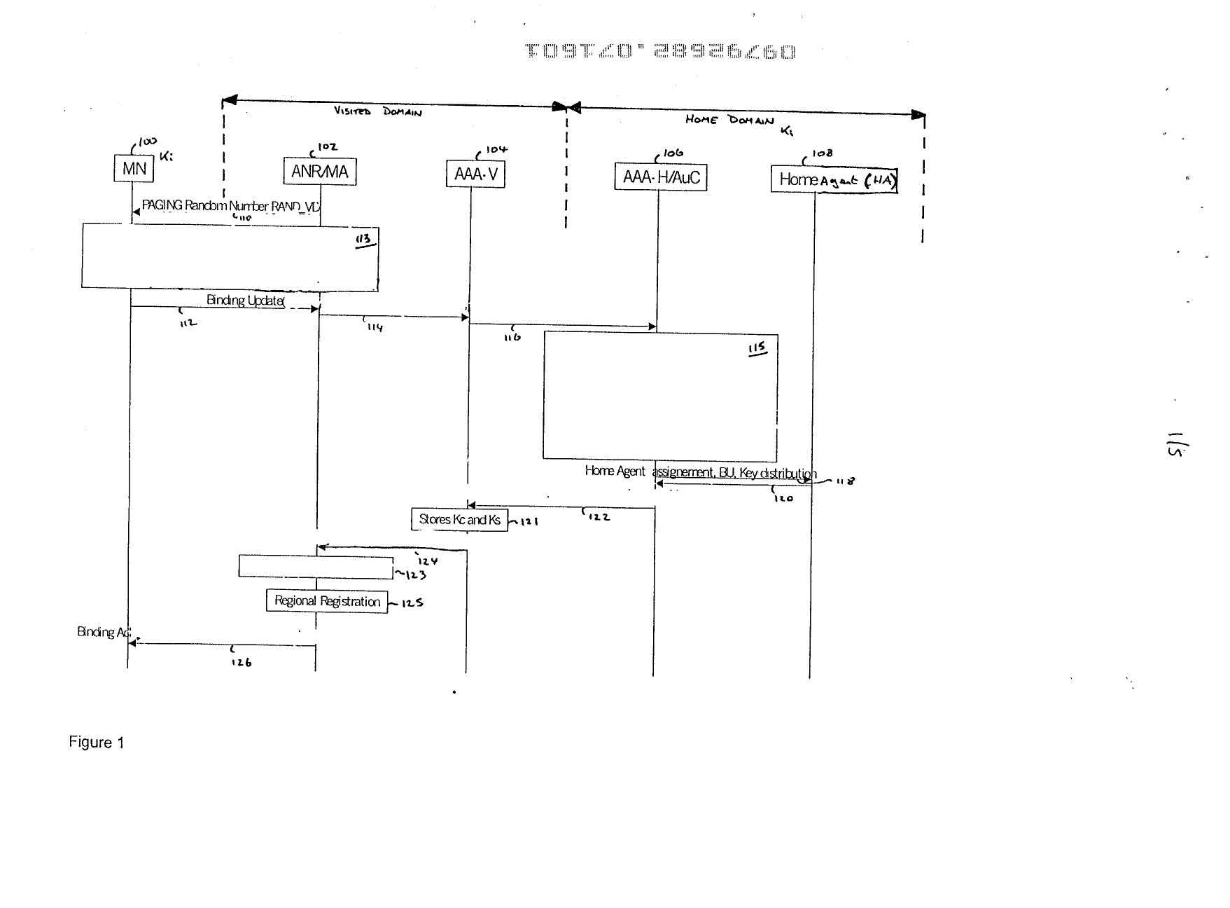

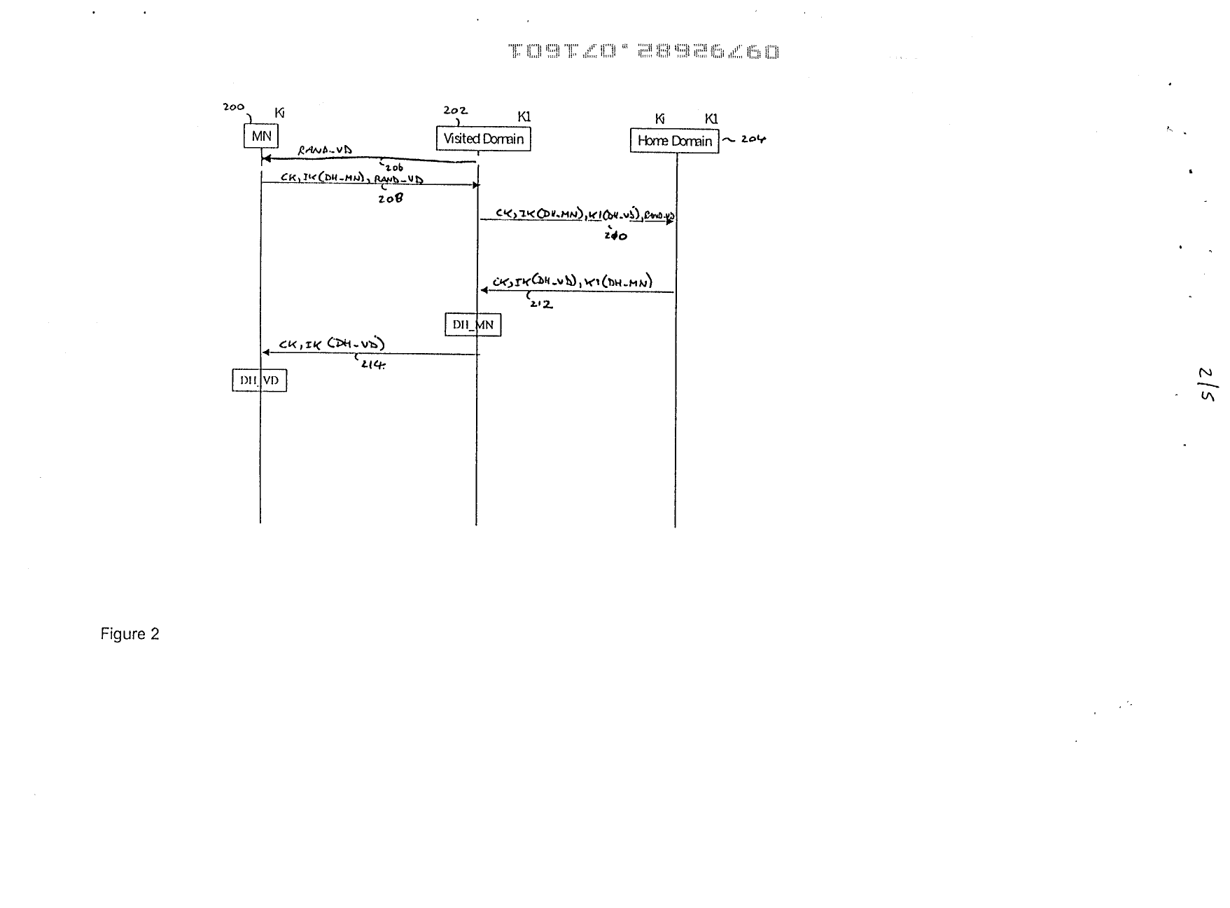

The first embodiment of the invention, described hereinbelow with reference to FIG. 1, is based on random numbers. The second embodiment, discussed hereinafter with reference to FIG. 2, is based on DH exchange.

In describing the first embodiment with reference to FIG. 1, it is assumed that: the MN and the home network have a long term secret Ki defining a security association therebetween; the home and visited networks share a security association allowing data to be set between these two networks securely; and the AAA-H and home agent also share a security association.

In this embodiment the key distribution is combined with the authentication procedure: before giving keys to any entity, the entity distributing the keys authenticates the parties first. However, the authentication procedure may also be performed separately.

The first embodiment of the present invention is described with reference to the various network elements shown in FIG. 1. The network elements comprise a mobile node (MN) 100, an access network router (ANR)/mobile agent (MA) 102, an AAA-V 104, a AAA-H/AuC 106, and a home agent (HA) 108.

In a first step, the access network router (ANR)/mobile agent (MA) 102 of the visited domain generates a first random number, RAND_VD, and pages it over the air interface as represented by arrow 110. The mobile node 100 powers on (or moves to a new visited network) and listens to the router advertisements, and the paged random numbers from the network. The MN also receives a current care-of-address (CoA), and a regional care-of-address (RCoA), from the network.

From the received random number, RAN_DVD, and the secret key Ki common to the mobile node and the home network, the mobile node 100 computes a master key Kc1 which is a function of these two numbers, i.e. Kc1=Fn(Ki, RAD_VD). The mobile node then derives the access network specific ciphering key (CK1) and the the access network specific integrity protection key (IK1) from Kc1 using functions L and M, i.e. L(Kc1)=CK1 and M(Kc1)=IK1. The ciphering and integrity protection keys are used to encrypt the data transmitted over the access link.

The mobile node then generates a second random number for network authorization being a mobile node random value RAND_MN for use in authenticating the network, and computes authentication data. The authentication data is computed from the value RAND_VD by using the key Ki and an authentication algorithm. Thus the authentication data can be identified as MN_AuthData.

All these computations are carried out in step 113.

The mobile node then sends a binding update (BU) to the ANR/MA as indicated by the arrow 112. The binding update includes the MN regional care-of-address MN_RCoA, the ciphered and integrity protected random number and authentication data MN_AuthData, i.e. CK1,IK1 (RAND_MN, MN_AuthData), the key request, a MAC value, and the visited domain random number RAND_VD.

The ANR/MA 102 receives the BU from the MN, and forwards it to the visited domain AAA server 104. Since this message carries a user authentication extension and a key request extension, the visited domain AAA server 104 forwards the request to the home AAA server 106 associated with the mobile node 100.

From the user identity, i.e. the identity of the mobile node, the server 106 retrieves Ki. The server 106 uses the RAND_VD value and computes the key Kc1 using Ki. The server 106 derives the keys CK1 and IK1 from Kc1 using the functions L and M, i.e. L(Kc1)=CK1 and M(Kc1)=IK1. The server 106 applies CK1 and IK1 to decipher and verify the integrity of the RAND_MN and MN_AuthData. . . The sever 106 computes a MN_AuthData based on RAND_MN and Ki. . The server deciphers the RAND_MN and MN_Auth Data and authenticates the MN based on Ki and MN AuthData. The server computes NW-Auth Data based on Ki and RAND-MN Based on Ki, AuC computes three sets of keys:

i) MIP Key: Km, Rand_KM

ii) Key for hierarchical mobility model: Ks, RAND_KS

iii) Cipjering Key:Kc2, RAND_Kc2

These computations are carried out in step 115.

The server 106 then verifies the MAC value to make sure the message has not been modified, and generates three further random values: RAND_Km, RAND_Ks, and RAND_Kc2. From these two values, it computes three sets of keys using functions G, H and J:

i) G (RAND_Km, Ki)=Km;

ii) H (RAND_Ks, Ki)=Ks; and

iii) J (RAND_Kc2, Ki)=KC2.

The AA-H/AuC 106 then chooses a home agent for the mobile node 100, and sends to the chosen home agent 108, as represented by arrow 118, the Mobile IP Key Km to share with the MN to authenticate subsequent Binding Updates (MN-HA authentication extensions), and requests the HA to make a binding between the Home address and the Regional Care of Address MN_RCoA of the MN. The Home Agent confirms the reception of the key Km and the Binding Updtae as represented by arrow 120.

The AAA-H/AuC 106 then sends all the keying material to the visited domain in a second message as represented by arrow 122. The second message comprises the network authentication data NW_AuthData, and the random values RAND_km, RAND_Kc2 and RAND_Ks ciphered and integrity protected by CK1 and IK1, i.e. CK1, IK1 (RAND_Km, RAND_Ks, RAND_KC2, RAND_MN, NW_AuthData). Message 122 comprises also the keys Ks and Kc2, and the MAC value. The AAA-H/AuC 106 includes the RAND_MN used to compute the NW_AuthData to allow the MN to verify the network authentication data correctly in case the MN has sent multiple RAND_MN to the home network for different authentication procedures, The AAA-V 104 keeps a copy of the master key Kc2 and the key Ks for the hierarchical mobility mechanism in step 121.

The AAA-V 104, after storing the values Kc2 and Ks, then transmits all the received information to the ANR/MA 102 as represented by arrow 124, which also stores the keys Kc2 and Ks in step 123. The content of the message represented by arrow 124 corresponds to that represented by arrow 122.

Kc2 is used in steps 123 to derive the access network specific ciphering key CK2 and integrity protection key IK2, which are used to cipher and protect data over the air interface, using the functions L and M, i.e. L(Kc2)=CK2 and M(Kc2)=IK2.

Ks is used to authenticate the binding updates for the hierarchical mobility model from the MN (MN-MA authentication extensions).

The ANR/MA 102 knows from the message received from the mobile node's home network that the user is a valid one, and as such the mobile node has been authenticated. The ANR/MA 102 therefore performs a Binding Update for the hierarhical mobility model as represented by block 125.

The ANR/MA 102 then sends a binding acknowledgement to the mobile node, as represented by arrow 126, to inform it of the success of the binding updates. The ANR/MA 102 also sends to the MN the network authentication data NW_AuthData, and the random values RAND_km, RAND_Kc2 and RAND_Ks ciphered and integrity protected by CK1 and IK1, i.e. CK1, IK1 (RAND_Km, RAND_Ks, RAND_KC2, RAND_MN, NW_AuthData). Message 126 comprises also a MAC value. MN verifies thanks to the MAC that the message has not been altered. MN deciphers and verity for integrity the RAND_Km, RAD_Ks, RAND_KC2, RAND_MN, NW_AuthData, MN authenticates the network based on NW_AuthData and Ki. MN uses Ki, F, H and J functions (see above) to compute Ks, Km and Kc2. The MN derives CK2 and IK2 from Kc2 using the functions L and M, i.e. L(Kc2)=CK2 and M(Kc2)=IK2, and can then use CK and IK2 to cipher and protect data sent over the access link to the ANR/MA.

If the registration for the hierarchical mobility mechanism fails, the mobile node must send a binding update to its home agent informing the regional CoA MN_RCoA is not valid, and requesting the home agent to use its current CoA.

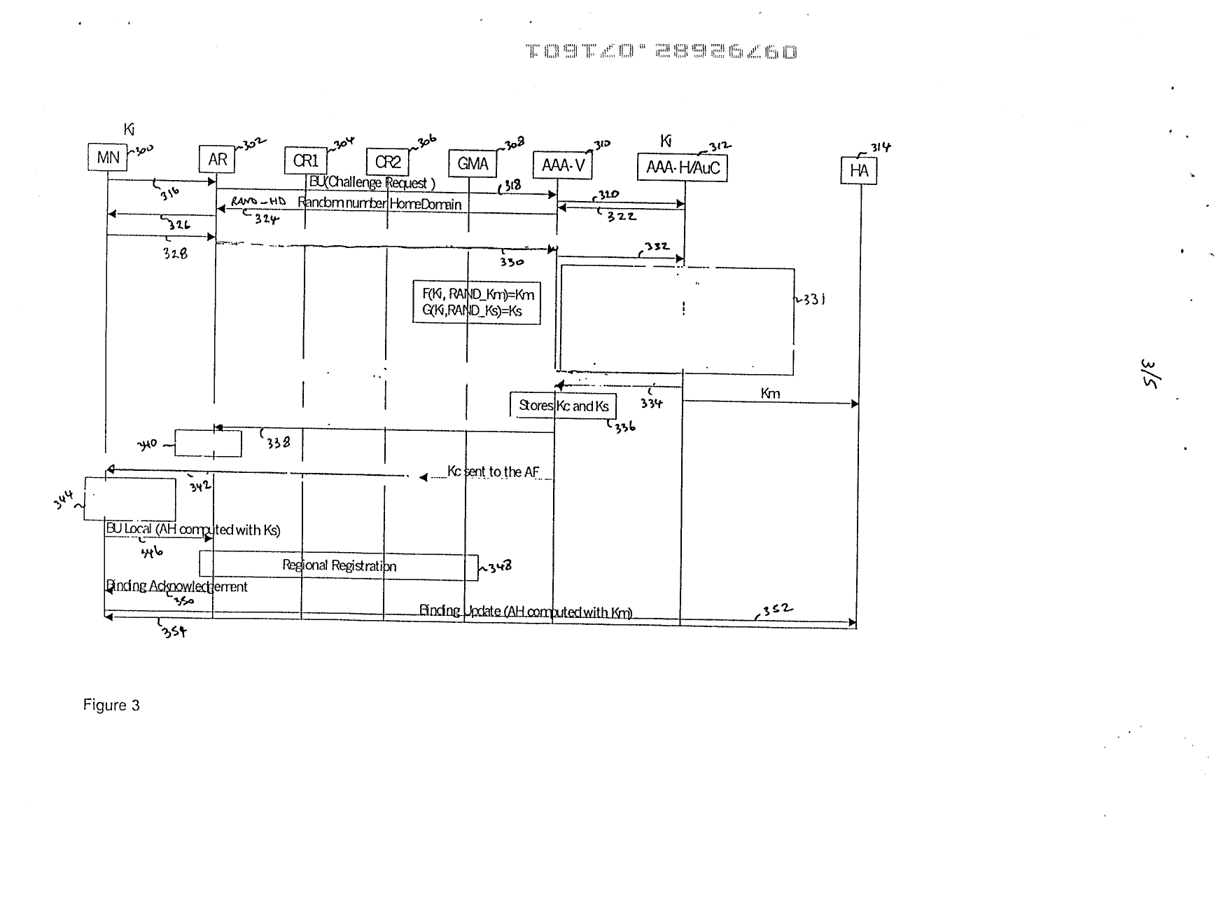

A number of alternatives to the technique described with reference to FIG. 1 are described hereinbelow with reference to FIGS. 3 to 5.

In a second embodiment, it is proposed that the keys may also be computed using the well known Diffie Hellman (DH) algorithm. The mobile node and the other entity with which it is communicating only need to exchange their DH public values in an authenticated way. An example embodiment utilising this technique is described hereinbelow with reference to FIG. 2.

In the following, a key establishment between the mobile node and the serving or visited domain is described, (i.e. establishment of Ks).

It is assumed that the MN and the Home Domain share a security association based on Ki, and that the visited domain and home domain share a security association based on K1.

In a first step, the access network router (ANR)/mobile agent (MA) 202 of the visited domain generates a first random number, RAND_VD, and pages it over the air interface as represented by arrow 206. The mobile node 200 powers on (or moves to a new visited network) and listens to the router advertisements, and the paged random RAND_VD from the network.

The mobile node 200 then generates its Diffie Hellman value DH using the Diffie Hellman algorithm. The MN 200 also computes a key Kc from Ki and RAND_VD using function J as indicated above, i.e. J(RAND_Kc, Ki)=Kc. The MN 200 derives the keys CK and IK from Kc using the functions L and M, ie L(Kc)=CK and M(Kc)=IK. As represented by arrow 208, the MN 200 sends its DH value, encrypted with CK and integrity protected with IK, i.e. CK, IK (DH_MN). Message 208 comprises also of RAND_VD. The Visited Domain 202 receives the first message but cannot decrypt it since it does not know how to compute Kc, and transmits it to the home domain 204 as represented by arrow 210. Before transmitting it to the home domain, the visited domain adds its own DH value encrypted with K1, i.e. the security association shared between the visited domain 202 and the home domain 204. At this point it should be noted that the visited domain may also be referred to as the serving domain.

The Home Domain 204 derives Kc from Ki and RAND_VD, and derives the keys CK and IK from KG using the functions L and M, ie. L(Kc)=CK and M(Kc)=IK. The Home Domain 204 can then decrypt both CK, IK (DH_MN) and K1 (DH_VD) to recover the mobile node DH value MN_DH, and the visited domain DH value VD_DH. The home domain then encrypts mobile node DH value, DH_MN, using K1, and the visited domain DH value, DH_VD, using CK and IK. The thus encrypted DH values are transmitted to the visited domain 202 as represented by arrow 212.

The visited domain receives DH_MN encrypted with K1. Since the visited domain has an established relationship with the home domain and trusts the home domain, it can decrypt the mobile node DH value encrypted with key K1 to recover the mobile node DH value. It knows DH_MN is the DH public value of the mobile node.

The visited domain forwards a message 214 comprising the visited domain DH value encrypted with key CK and integrity protected by IK, compiled by the home domain 201, to the mobile node 200.

In the same way as the visited domain, when the MN receives CK, IK (DH_VD), it can decrypt using CK and IK. Since it trusts its home domain, it knows DH_VD is the DH public value of the visited domain,

The mobile node and the visited domain have at this point exchange the respective DH public values in an authenticated way and can both compute the DH key Ks by using DH_MN and DH-VD. The keys Kc2 and Km may be established in the same way, using the DH mechanism and different DH values, one for each of the three keys to be established. This procedure has the advantage to set up keys at points in the network (namely MN 200 and Visited Domain 202) without having to send any key over the network.

In the described embodiments, the home domain is used to authenticate the DH public value of the different network entities. In the future, when PKI is implemented, the PKI infrastructure may be used to substitute the home domain role and authenticate the DH public values. This scheme therefore allows easy evolution towards PKI.

In addition, in the above-described embodiments, user authentication is based on symmetric key mechanisms (Ki). However if the mobile node and the home domain have Public Keys, Public Key authentication mechanisms can also be used.

The solution may be implemented in existing networks by adding: new extensions in Diameter; or new extensions in Mobile IP.

In the embodiment illustrated in FIG. 1, the random number is generated by the visited network. Compared to generation by the home network, this saves one round trip between the visited and the home networks. However, if the network operators prefers, the home network may generate the random value. The random value may still be paged over the air, but as an alternative the mobile node may first send a challenge request to the visited domain and the visited domain forwards it to the home network, and receive the random number responsive thereto.

In the embodiment illustrated in FIG. 1, the random value generated by the serving system is used for user authentication and ciphering key computation. In an alternative, this random value may be used for user authentication only, and the home domain may generate the ciphering key Kc in the same way chat it computes the keys Km and Ks.

There are three possibilities for sending the keying material to the mobile node over the air interface, as detailed hereafter.

“In cleartext”: Any user which captures RAND_Km, Kc_mat and RAND_Ks, does not know Ki and therefore can not compute Km, Kc nor Ks. For that reason, the keying material can be sent in “cleartext”

Encrypted with a temporal Key shared between the MN and the Home Domain: A temporal key Kt may be derived from Ki and used to encrypt RAND_Km, RAND_Ks and Kc_mat. This adds another level of protection: to know Km, Ks and Kc, two levels of security must be broken: Kt and Ki. But Kt needs to be re-freshed.

Encrypted with the session key. The mobile node and the visited domain must first share the session key Kc. This can be realized as indicated in the case above (generation of the challenge number by the visited domain). Then RAND_Km and RAND_Ks can be sent encrypted over the air interface.

For integrity protection, a MAC can be computed over every message or if preferred, a MAC can be computed over RAND_Km, another over RAND_Ks, and eventually one over Kc_mat.

Computing different MACs, the user may know which one is corrupted, and request a new value for this specific set. However, this results in more MACs being sent over the air interface.

Depending on the access link technology, the access link may have a limited ability to carry information and may not be able to carry all the parameters such as the key request, the random value generated by the MN to authenticate the network, etc.

Therefore the procedure may be split into different parts. After receiving the challenge, the user only sends back the user authentication data; and then once the user is authenticated and a dedicated channel assigned, the mobile node can request key distribution and network authentication.

The operators may not let the user send too much information over the air before authentication.

In the embodiments described hereinabove, there is described the combination of the authentication procedure, the key distribution, the mobile IP hierarchical mobility mechanism and the mobile IP home registration. However, one skilled in the art will appreciate that all these procedures can be performed separately or ordered differently. Various possibilities will be presented and described with reference to FIGS. 3 to 5. However, further modifications may exist and the variations described below are in no way limiting. It should be noted that in FIGS. 3 to 5 a number of operations are shown which correspond directly to those described hereinabove with reference to FIGS. 1 and 2. For conciseness, only those message exchanges necessary for an understanding of the modifications presented are described in detail.

Reference is now made to FIG. 3. The MN 300 powers on or moves to a new visited domain and listens to the router advertisements. The MN 300 creates and sends (arrow 316) a Binding update (BU) request: the destination address is the Mobility Agent (AR) 302 whose address has been provided during the router advertisement. The BU includes the identity of the user, which is the user's NAI, and also include a Challenge Request to indicate to the home network the need to register and be authenticated.

The AR receives the BU from the MN and since this message carries a Challenge Request, it forwards the request (arrow 318) to the local AAA server 310, which transfers it to the Home Network of the user (arrow 320). The AAA-H/AuC 312 generates a random number RAND_HD and sends it to the MN (arrows 322, 324, 326).

This random number provides a strong authentication mechanism, and also serves for anti replay attacks. Timestamp is a possible alternative: it requires fewer messages but requests secured synchronized clocks between the MN 300 and the AAA-H/AuC 312.

From the received random number, RAND_HD, and the secret key Ki common to the mobile node and the home network, the mobile node 300 computes a master key Kc1 which is a function of these two numbers, i.e. Kc=Fn(Ki, RAND_HD). The mobile node then derives the access network specific ciphering key (CK1) and the the access network specific integrity protection key (IK1) from Kc1 using the functions L and M, i.e. L(Kc1)=CK1 and M(Kc1)=CK1 and M(Kc1)=IK1. The ciphering and integrity protection keys are used to encrypt the data transmitted over the access link.

The mobile node then generates a second random number being a mobile node random value RAND_MN for use in authenticating the network, and computes authentication data MN_AuthData. The authentication data is computed from the value RAND_HD by using the key Ki and an authentication algorithm.

The MN then sends a BU including the authentication data MN_AuthData, computed with Ki, and a Key Request (arrow 328) The binding update includes the ciphered and integrity protected random number and authentication data MN_AuthData, i.e. CK1,IK1 RAND_MN, MN_AuthData), the key request, a MAC value, and the home domain random number RAND_HD.

The BU is forwarded to the AAA-H (arrows 330, 332). The AAA-H/(AuC 312 verifies the MAC value to make sure the message has not been modified. From the user identity, i.e. the identity of the mobile node, the server AAA-H(AuC 312 retrieves Ki. The AAA-H/AuC 312 derives Kc1 from Ki and RAND_HD, and derives CK1 and IK1 from Kc1. The AAA-H/AuC 312 will then decipher and verify the integrity of RAND_MN and MN_AuthData, and authenticates the user by using MN_AuthData and Ki. The AAA-H/AuC 312 computes NW_AuthData based on Ki and RAND_MN. Finally, the AAA-H/AuC 312 generates three further random values: RAND_Km, RAND_Ks, and RAND_Kc2. From these three values, the AAA-H/AuC 312 computes three sets of keys using functions G, H and J:

i) G (RAND_Km, Ki)=Km;

ii) H (RAND_Ks, Ki)=Ks; and

iii) J (RAND_Kc2, Ki)=KC2.

Thus in box 331 the AAA-H/AuC derives Kc1 from Ki and Rand-HD, derives CK1 and IK1 from Kc1, authenticates the MN based on MN_AuthData and Ki. Further NW_AuthData is computed based on Ki and RAND_MN. Based on Ki, AuC computes three sets of keys:

i) MIP Key: Km, RAND_Km

ii) Key for hierarchical mobility model: Ks, RAND_Ks

iii) Ciphering Key: Kc2, RAND_Kc2

The AAA-H/AuC 312 then chooses a Home Agent and sends the Mobile IP key Km to the selected HA.

The AAA-H then sends the keying material to the AAA-V (arrow 334) in a message containing the ciphered and integrity protected RAND_Km, RAND_Ks, RAND_KC2, RAND_MN, NW_AuthData, i.e. CK1, IK1 (RAND_Km , RAND_Ks, RAND_KC2, RAND_MN, NW_AuthData). Message 334 comprises also the keys Ks and Kc2, and a MAC. The AAA-v 310 stores the keys Kc2 and Ks (step 336). A security association between the home and visited domains enables the AAA-H and the AAA-V servers to exchange data in a secure way.

The AAA-V 310 transfers the keying material to the AR which will enable the MN to compute the required keys, including the network authentication data the MN will use to authenticate the network (arrow 338). Message 338 contains the ciphered and integrity protected RAND_Km, RAND_Ks, RAND_KC2, RAND_MN, NW_AuthData, i.e. CK1, IK1 (RAND_Km, RAND_Ks, RAND_KC2, RAND_MN, NW_AuthData). Message 338 comprises also the keys Ks and Kc2, and a MAC.

The AR 302 stores the key Ks (step 340) and the key Kc2, and derives CK2 and IK2 from Kc2 using the functions L and M, i.e. L(Kc2)=CK2 and M(Kc2)=IK2. The AR 302 forwards the the ciphered and integrity protected RAND_Km, RAND_Ks, RAND_KC2, RAND_MN, NW_AuthData, i.e. CK1, IK1 (RAND_Km, RAND_Ks, RAND_KC2, RAND_MN, NW_AuthData), the MAC to the MN (arrow 342).

MN (steps 344) verifies thanks to the MAC that the message has not been altered. MN deciphers and verify for integrity the RAND_Km, RAND_Ks, RAND_KC2, RAND_MN, NW_AuthData. MN authenticates the network based on NW_AuthData and Ki. MN uses Ki, F, H and J functions (see above) to compute Ks, Km and Kc2. The MN derives CK2 and IK2 from Kc2 using the functions L and M, i.e. L(Kc2)=CK2 and M(Kc2)=IK2, and can then use CK2 and IK2 to cipher and protect data sent over the access link to the ANR/MA.

The MN then performs a BU for the hierarchical mobility mechanism with the Visited Network (arrow 346).

Once the registration for the hierarchical mobility mechanism (step 348) has succeeded, as indicated by arrow 350, the MN executes a BU with its HA (arrows 352, 354).

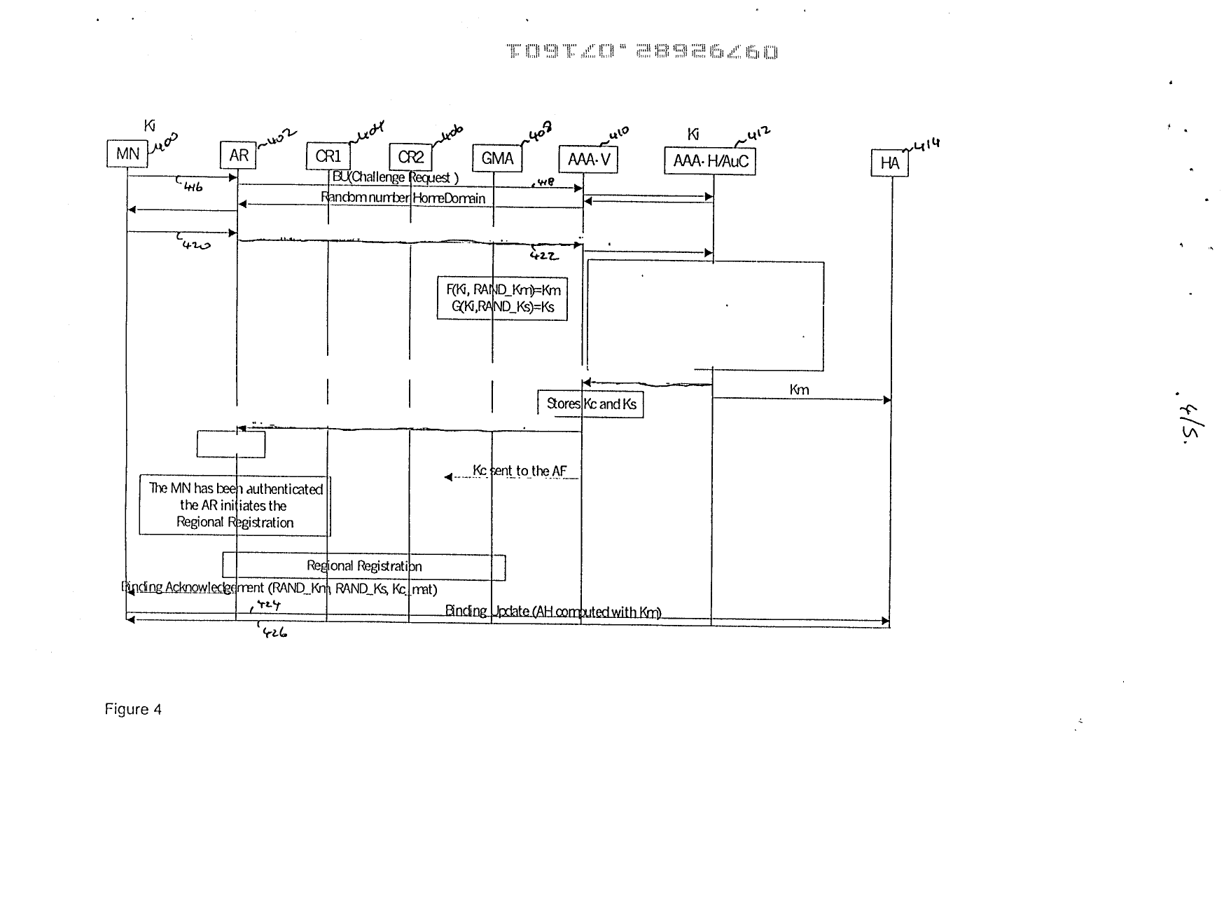

An alternative embodiment is shown in FIG. 4. Reference is now made to FIG. 4, which illustrates a modification in which the key request and the registration for the hierarchical mobility mechanism are combined.

The first BU (arrow 416, 418) requests the Challenge. The second BU (arrows 420, 422) carries the authentication data and the key request. After the Home network has authenticated the user, the AR knows that the MN is a valid one and since it has the key for the hierarchical mobility mechanism, it can initiate the registration procedure for the hierarchical mobility mechanism thus saving one round trip over the air interface.

The third BU (arrows 424, 426) is a BU with the MN's Home Agent: the AR cannot perform this BU because it does not have the Mobile IP Key.

In the example of FIG. 4, the number of messages sent over the air interface is reduced to six.

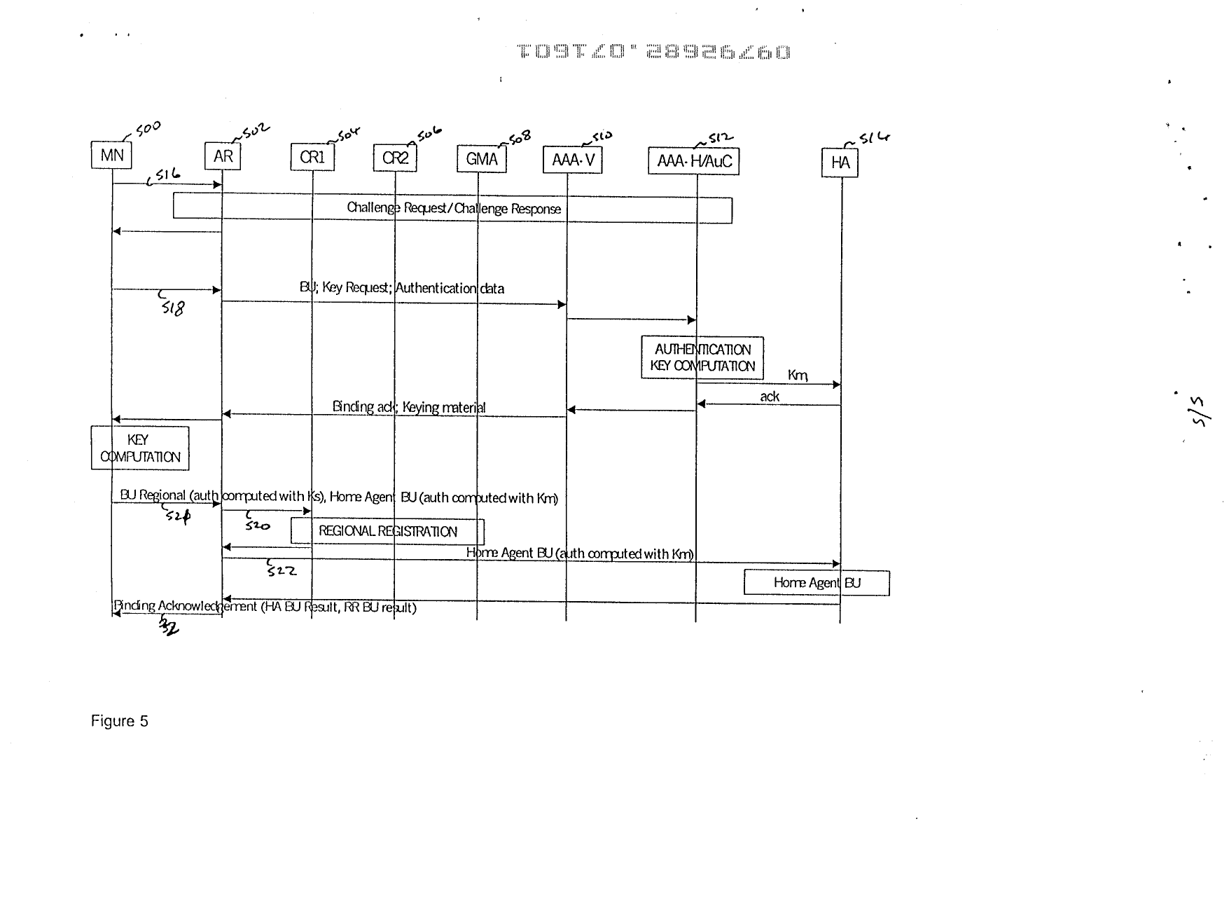

An alternative embodiment is shown in FIG. 4. Reference is now made to FIG. 5. A first BU 516 requests the Challenge A second BU 518 carries the authentication data and the keying material.

A thud BU 521 includes two BUs: one 520 for the hierarchical mobility mechanism and one 522 for the HA BU (this latter one will be computed with MN Mobile IP key). The AR will first perform the registration for the hierarchical mobility mechanism; if it fails then the AR informs the MN without executing the HA BU. Inn the case of success, it transmits the HA BU to the MN's Home Agent.

What is claimed is:

1. A method of establishing a connection between a mobile station and a serving domain, in which a first security association exists between the mobile node and an associated home domains and a second security association exists between the serving domain and the home domain, the method comprising: transmitting a first message from the mobile node to the serving domain, the first message being encrypted in accordance with the first security association; transmitting the first message from the serving domain to the home domain; decrypting the first message in the home domain in accordance with the first security association; transmitting a second message from the home domain to the serving domain, the second message being encrypted according to the first security association; transmitting the second message from the serving domain to the mobile node; decrypting the second message in the mobile node in accordance with the first security association.

2. The method of claim 1 wherein the first message comprises authentication data.

3. The method of claim 1 wherein the mobile node receives a first random number from the serving network.

4. The method of claim 3 wherein the mobile node computes a master key derived from the first security association and the first random number.

5. The method of claim 4 wherein the mobile node derives access network specific ciphering keys and access network specific integrity protection keys from the master key.

6. The method of claim 5 wherein and the mobile node generates a second random number itself, for use in network authentication.

7. The method of claim 6 wherein authentication data is derived from an authentication algorithm applied to the first random number and the first security association.

8. The method of claim 7, wherein the first message her comprises the first random number.

9. The method of any claim 7 wherein the first message further comprises a key request.

10. The method of claim 7, wherein the first message is a binding update.

11. The method of claim 7 wherein the authentication data is ciphered and integrity protected.

12. The method of claim 11 wherein responsive to receipt of the first message, the home domain authenticates the mobile node.

13. The method of claim 11 wherein the home domain decrypts the authentication data in accordance with the first security association, and compares the decrypted first random value with the transmitted first random value.

14. The method of claim 13, wherein the home domain derives the master key based on the first security association.

15. The method of claim 14, wherein the home domain derives the access network specific ciphering keys and access network specific integrity protection keys from the master key.

16. The method of claim 15, wherein the home domain generates authentication data comprising the first random number, a third random number associated with the mobile node, and a value identifying the mobile node, encrypted in accordance with the first security association.

17. The method of claim 16 wherein the second message includes the authentication data.

18. The method of claim 17, wherein the home network generates a fourth random number being a mobile IP random number, a first key being a mobile IP key being generated based on said fourth random number.

19. The method of claim 18 wherein the home network generates a fifth random number being a random number for the hierarchical mobility mechanism and a second key being a key for the hierarchical mobility mechanism being generated based on said fifth random number.

20. The method of claim 19, wherein said keys are further based on the first security association.

21. The method of claim 20, wherein said second message further includes said fourth and fifth random numbers and said second key.

22. The method of claim 21, wherein the home network provides the first key to a home agent allocated to the mobile node.

23. The method of claim 22, wherein on receipt of said second message said serving domain stores said second key.

24. The method of claim 1, wherein the mobile node calculates a mobile node value based on a known function.

25. The method of claim 24, wherein the known function is the Diffie Hellman algorithm.

26. The method of claim 1, wherein the serving domain calculates a serving domain value based on the known function.

27. The method of claim 26, wherein the step of transmitting the first message from the serving domain to the home domain comprises adding the serving domain value to the message encrypted in accordance with the second security association.

28. The method of claim 27, wherein the step of decrypting in the home domain the first message and the serving domain value added by the serving domain comprises recovering the mobile node value and the serving domain value.

29. The method of claim 28, wherein the step of transmitting the second message comprises encrypting the mobile node value according to the second security association and encrypting the serving domain value according to the first security association.

30. The method of claim 29, wherein the serving domain decrypts the second message based on the second security association to recover the mobile node value

31. The method of claim 30, wherein the mobile node decrypts the second message based on the first security association {see comments in claim 1 for this first security association } to recover the visited domain value.

32. The method of claim 31, wherein the mobile node and the visited domain compute a key based on the a function of the mobile node value and visited domain value.

33. The method of claim 32, wherein the function is a Diffie-Hellman function.

34. A communication system including a mobile station being associated with a serving domain and having a home domain, in which a first security association exists between the mobile node and an associated home domain, and a second security association exists between the serving domain and the home domain, wherein connection is established between the mobile station and the serving domain by: transmitting a first message from the mobile node to the serving domain, the first message being encrypted in accordance with the first security association; transmitting the first message from the serving domain to the home domain; decrypting the first message in the home domain in accordance with the first security association; transmitting a second message from the home domain to the serving domain, the second message being encrypted according to the first security association; transmitting the second message from the serving domain to the mobile node; decrypting the second message in the mobile node in accordance with the first security association.
